(19) United States
(12) Patent Application Publication
(10) Pub. No.: US 2023/0288731 A1
(43) Pub. Date: Sep. 14, 2023

(54) SYSTEM AND METHOD FOR DYNAMIC CORRECTION OF ASTIGMATISM

(71) Applicants: Kent State University, Kent, OH (US); META PLATFORMS TECHNOLOGIES, LLC, Menlo Park, CA (US)

(72) Inventors: Amit Kumar Bhowmick, Kent, OH (US); Doug Bryant, Aurora, OH (US); Philip Bos, Hudson, OH (US); Afsoon Jamali, Redmond, WA (US)

(21) Appl. No.: 18/120,004

(22) Filed: Mar. 10, 2023

Related U.S. Application Data
(60) Provisional application No. 63/269,116, filed on Mar. 10, 2022.

(51) Int. Cl. G02C 7/08

(52) U.S. Cl. CPC G02C 7/083; G02C 2202/22; G02C 2202/18

(57) ABSTRACT

A non-mechanical, electrically tunable optical system provides both focus and astigmatism power correction with an adjustable axis. The optical system includes three liquid crystal based cylindrical lenses which are simple, low cost, and have compact flat structure.

This application claims the benefit of U.S. Provisional Application No. 63/269,116, filed Mar. 10, 2022 and titled “LIQUID CRYSTAL LENS FOR DYNAMIC CORRECTION OF ASTIGMATISM,” which is incorporated by reference in its entirety.

### BACKGROUND

Two common distortions in an optical system are defocus and astigmatism. Defocus is corrected by a circularly symmetric lens of a specified optical power. Astigmatism is corrected by a cylindrical lens of a specified power and a specified axis of the cylindrical lens.

Astigmatism in an optical system can occur due to a distortion of an optic component along an axis in the plane of the component. This can occur in light weight optical systems due to mechanical or thermal stress. As an example, consider a large telescope mirror that becomes slightly folded along an axis in the plane of the lens. It is also a common distortion in the human eye lens.

There is a need for a device that can be programmed to correct for an arbitrary degree of defocus and astigmatism. This is needed in optical systems that, due to thermal and mechanical stresses, have a changing degree of defocus and astigmatism. Or in an optical system to be viewed by different humans, without using vision correcting glasses, that require correction of defocus and astigmatism. For example, a virtual reality headset where there is not room for a user's glasses.

There is a long history of optical system designs to dynamically correct for errors in focus and astigmatism. In 1849, Stokes demonstrated that combining two equal but opposite-powered cylindrical lenses (plano-convex and plano-concave) can vary the power and principal meridians of the optical axis of the system. When two cylindrical lenses are rotated by the same angle from zero position, but one along the clockwise direction and the other along the counterclockwise direction, the resultant cylindrical power of the device will vary from zero to a maximum value, keeping the angle of the principal axis fixed. The residual spherical power of the Stokes lens is equal to half the value of the resultant cylindrical power. Later, Foley and Campbell showed a variable astigmatic lens with two identical spherocylindrical lenses. In contrast to Stokes lens, Campbell's proposed lens can generate any mean spherical power depending on the rotation of the lenses in the set. There are several other well-established mechanical methods for controlling variable aberration; however, a non-mechanical system is desired to reduce complexity and the electrical power requirement.

In the field of adaptive optics, there has been a broad range of work done over the past decade to replace conventional mechanically controlled rigid lenses by tunable lenses; however, variable focal length devices have been the most studied. Only a few reports have been made that cover simultaneous control of focal length and astigmatism. Each one of the approaches has its own drawbacks.

Electrowetting based fluidic lenses are realized by deformation of the curvature of fluids in a cavity resulting from an applied electrical field. An example is provided in U.S. Pat. No. 7,826,146 to Campbell, which is incorporated by reference herein. Although a fluidic lens can provide good optical quality, it suffers from gravitational sagging and surface tension. As a result, a coma wavefront error occurs at an equilibrium state. Membrane-based elastomeric lenses are also shape-changing lenses. However, in contrast to fluidic lenses, they do not suffer from a deformed surface in an unstrained state. Both fluidic lenses and elastomeric lenses are not flat, and the large aperture device is challenging to fabricate. Recently, a deformable but flat lens is reported based on metasurfaces combined with dielectric elastomer actuators. The reported device modulates the optical wavefront by a subwavelength spaced nanostructured pattern, varied by the application of electric field; however, the current form suffers from slow speed and a high voltage requirement.

Dynamic wavefront corrector devices are also realized based on liquid crystal technology. However, most of the approaches can only correct defocus. Few approaches such as liquid crystal-based light modulator, segmented electrode patterned lens are realized that can correct astigmatism. Liquid Crystal Spatial Light Modulator (LC SLM) devices are mostly used as reflective devices. There are few transmissive LC SLM reported. Due to larger pixel fill factor and smooth transition between pixels, reflective LC SLM has higher zero-order diffraction efficiency than transmissive LC SLM. Current transmissive SLM technology contains a light blocking mask over sections of its area to cover transistors and wiring electronics, which reduces the fill factor and degrades image quality due to diffraction. Another limitation of transmissive LC SLM is that the optical path difference pattern of each pixel is controlled separately, which introduces residual wavefront error (RWFE) at every pixel. Such RWFE causes phase discontinuity and imposes periodic phase structure varying across the aperture, which degrades transmission, zero-order diffraction efficiency, and image quality. A device was with hexagonal pixels by directly driving through an individual electrode, which limits the total number of pixels that can be implemented within an aperture; hence, a large aperture device is hard to realize. Although the published results show the capabilities of wavefront correction, the image quality and zero-order diffraction efficiency of transmissive LC SLM raise questions about the practical application of such devices for the correction of large amounts of astigmatism in a transmissive system.

### BRIEF DESCRIPTION

The present disclosure relates to systems and methods for non-mechanical, electrically tunable focus and astigmatism correction. It includes three liquid crystal based cylindrical lenses that are stacked on top of each other. The center points of these three cylindrical lenses are aligned on a common center axis that is normal to their surface, with their cylindrical axes rotated about an axis normal to their surface, by 0°, 45°, and 90°, respectively. The power of each cylindrical lens is controlled by its parabolic optical phase profile. The parabolic profile is controlled by linear electrodes associated with each cylindrical lens that are parallel to the symmetry axis of the lens. The optical phase gradient is perpendicular to the symmetry axis of the lens. Both the phase gradient axis and the symmetry axis of the lens lie in the plane of the lens. Precise control of voltage distribution over electrodes results in variable optical power of each cylindrical lens on the stack. This device is surprisingly capable of dynamic astigmatism correction (power and axis) without any mechanical movement.

This transmissive technology can provide astigmatism correction with an adjustable axis and focus tuning. The device needs no mechanically moving parts, requires very low driving voltages (e.g., <5 V), and is flat, thin (e.g., about 5 mm), is lightweight, and of low cost to fabricate.

Disclosed, in some embodiments, is a liquid crystal device including: a first liquid crystal based cylindrical lens comprising a first plurality of liquid crystal cells; a second liquid crystal based cylindrical lens aligned with the first liquid crystal based cylindrical lens at a common center axis and rotated by 45° in a first direction relative to the first liquid crystal based cylindrical lens, the second liquid crystal based cylindrical lens comprising a second plurality of liquid crystal cells; and a third liquid crystal based cylindrical lens aligned with the first liquid crystal based cylindrical lens and the second liquid crystal based cylindrical lens at the common center axis and rotated by 90° in the first direction relative to the first liquid crystal based cylindrical lens, the third liquid crystal based cylindrical lens comprising a third plurality of liquid crystal cells.

The plurality of liquid crystal cells may contain two anti-parallel rubbed liquid crystal cells.

In some embodiments, each cell is filled with a nematic liquid crystal with a positive dielectric anisotropy.

Each cell further may further include a plurality of electrodes. The electrodes and the liquid crystal layer are located between a first transparent substrate and a second transparent substrate.

The electrodes may include striped electrodes and/or may contain indium tin oxide (ITO).

In some embodiments, the device has no mechanically moving parts.

A driving voltage of the device may be less than 5 volts (e.g., 1 to 4.9 volts, 2 to 4.5 volts, 3 to 4.5 volts, 3.5 to 4.5 volts, and 3.8 to 4.2 volts).

The device may have a thickness of about 1 to 10 mm, including 2 to 9 mm, 3 to 8 mm, 4 to 6 mm, and about 5 mm.

Articles including the devices (e.g., eyeglasses, telescopes, and imaging lenses) are also disclosed.

Disclosed, in further embodiments, is a non-mechanical device for correcting for astigmatism over a wide range of resulting power and angle of an optical phase gradient axis.

The range of optical power may be between −10 and +10 Diopters.

In some embodiments, the range in the phase gradient axis angle is between 0 and 360 degrees.

The optical phase profile, which sets the optical power of the cylindrical lens, is controlled by voltages applied to the liquid crystal layer by electrodes.

In some embodiments, the device includes three cylindrical lenses stacked in optical series such that light passes through each lens sequentially.

The three cylindrical lenses are rotated relative to each other about an axis perpendicular to the plane of the lenses, the angle of the second lens being at 45 degrees relative to the first lens, and the third lens being at 90 degrees relative to the first lens.

In some embodiments, the aperture of each lens is greater than 1 cm.

Disclosed, in other embodiments, is a method for designing a non-mechanical device for correcting for astigmatism. The method includes defining the optical phase profiles of three cylindrical lenses of the device based on the equations as described herein.

These and other non-limiting characteristics are more particularly described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1A is a schematic diagram of a liquid crystal based tunable three cylindrical lens device in accordance with some embodiments of the present disclosure. The rectangles represent a view of three cylindrical lenses as viewed along an axis that is perpendicular to the plane of the lenses. The change in the intensity of color shows the voltage variations on each lens. FIG. 1B is a vector representation of the symmetry axis of the three cylindrical lens system, The optical power of each of the three lenses is designated as D₀, D₄₅, and D₉₀. FIG. 1C shows the phase gradients on the planes of the lenses.

FIG. 2A is a contour map of the total OPD defined as the optical phase multiplied by the wavelength of light and divided by 2π when the powers of three lenses are D₀=−4.63 D, D₄₅=1.00 D, D₉₀=−6.37 D. FIG. 2B is a contour map of the OPD when a spherical lens of +6 D (DR) is added to the lens stack of FIG. 2A.

FIG. 3A is a top view schematic diagram of a LC based tunable three cylindrical lens device in accordance with some embodiments of the present disclosure. With the same viewpoint as FIG. 1A. Here, the stripes are show the direction of the linear electrodes that are on the placed on the inner surface of one of the substrates of each lens.

FIG. 3B is a top view of a fabricated device, wherein the green dotted circle represents that active area and red circle represents 5 mm diameter lens area at the center of the device.

FIG. 3C includes side views of one of the lenses (D₉₀) of FIG. 3B within the red circle area in the OFF state (left) and the ON state (right). The lens includes two liquid crystal cells (anti-parallel rubbed) where the electrodes on the inner substrates are seen edge-on. Both figures only show a small representative number of the electrodes. The blue arrows show the rub direction of the surface alignment layer, green ellipses represent LC director. Approximate voltage values are assigned on the stripe electrodes and common electrode to represent the OFF/ON state.

FIG. 4 is a flow chart illustrating a non-limiting fabrication method in accordance with some embodiments of the present disclosure.

FIG. 5 is a side cross-sectional view of a liquid crystal lens in accordance with some non-limiting embodiments of the present disclosure.

FIGS. 6A-F illustrate numerically calculated far-field spot profiles of a designed device at 125 cm distance, wherein a principal axis of the cylindrical lenses of the device are perpendicular to phase variation axis. In FIG. 6A, all LC lenses are OFF and a monochromatic light source of wavelength 543.5 nm and beam width 5 mm is passed through the simulated device. In FIG. 6B, the LC lens which has phase variation along 0°-axis has power of +0.80 D, and the other two lenses are in the OFF state. In FIG. 6C, the LC lens which has phase variation along 90°-axis has power of +0.80 D and the other two lenses are in the OFF power state. In FIG. 6D, the LC lens which has phase variation along 135°-axis has power of +0.80 D and the other two lenses are in the OFF state. In FIG. 6E, the LC lenses which have phase variation along 0°-axis and 90°-axis have power of +0.80 D, and phase variation along 135°-axis lens is at 0 D power. In FIG. 6F, all three LC lenses (D0, D90, D45) on the device stack are +0.80 D.

FIGS. 7A-F illustrate experimental far-field spot profiles of the designed device at 125 cm distant, wherein the red circle shows the original beam size. At the lower right side within the yellow box of each figure, the phase profile of fabricated LC lens for corresponding power configuration is shown. The principal axis of the cylindrical lenses of the stack is perpendicular to phase variation axis. In FIG. 7A, all LC lenses are OFF. In FIG. 7B, the LC lens which has phase variation along 0°-axis has power of +0.80 D, and other two lenses are in the OFF state. In FIG. 7C, the LC lens which has phase variation along 90°-axis has power of +0.80 D, and other two lenses are in the OFF power state. In FIG. 7D, the LC lens which has phase variation along 135°-axis has power of +0.80 D, and other two lenses are in the OFF state. In FIG. 7E, the LC lenses which have phase variation along 0°-axis and 90°-axis have optical power of +0.80 D, and the 135°-axis phase variation lens is at 0 D power. In FIG. 7F, all three LC lenses (D0, D90, D45) on the device stack are at +0.80 D.

FIG. 8A-B includes graphs comparing experimentally obtained far-field intensity profile with modeled diffraction limited device far-field intensity profile at focal plane. FIG. 8A shows the simulated intensity profile of the modeled device at power configuration shown in FIG. 6D. FIG. 8B shows the experimentally obtained intensity profile for the case described in FIG. 7D.

FIG. 9A-D includes images from a tunable prescription (Rx) correction example. FIG. 9A shows the experimental far-field spot profile of the device at the focal plane of cylindrical power. FIG. 9B shows the simulated far-field spot profile of the device at the focal plane of cylindrical power. FIG. 9C shows the experimental far-field spot profile of the device at the focal plane of spherical power FIG. 9D show the simulated far-field spot profile of the device at the focal plane of spherical power.

FIG. 10 illustrates astigmatism correction with a built device. The left image illustrates 1951 USAF resolution test chart under white light illumination. The center image was taken when glass cylindrical lens of power +0.75 D along X-axis is added to the optical setup and all the lens of the built device is kept at 0 D. The right image was taken under the same conditions as FIG. 10B but the built device power configuration is −0.80 D, 0 D, 0 D along 0°, 90°, 45°, respectively.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps.

However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a non-mechanical, electrically tunable focus and astigmatism corrector consisting of three liquid crystal-based cylindrical lenses.

The device includes a stack of three liquid crystal based tunable cylindrical lenses, that each have an optical phase gradient axis perpendicular to the axis of cylindrical symmetry. Each tunable cylindrical lens has a parabolic optical phase profile whose phase gradient axis is perpendicular to symmetry axis of the lens. The symmetry axis of the second and third lenses are rotated by 45 and 90 degrees relative to the first lens. Linear electrodes are placed on the inner surfaces of the substrates that contain the liquid crystal material. Controlling the voltages on the electrodes controls the orientation of the liquid crystal material, which results in a tunable parabolic phase profile of each cylindrical lens on the device stack. The voltage profile provided to each cylindrical lens, controls the magnitude of the parabolic phase profile and the optical power, of each lens.

The method for producing a non-mechanical device that can correct for astigmatism in an optical system, by creating an effect cylindrical lens of tunable power and symmetry axis is now explained. Starting with the equation for the combined cylindrical power D_{c} (in diopters) of two cylindrical lenses of power D₁ and D₂, where the axis of cylindrical symmetry of one lens is rotated with respect to the other by an angle δ about an axis perpendicular to the plane of the lenses.

Dc=D²₁+D²₂+2×D₁×D₂×cos(2δ) (1).

The resulting the spherical lens power of this combination is:

$$Ds = \frac{{D}_{1} + {D}_{2} - Dc}{2} . \qquad ( 2 )$$

Adding a third cylindrical lens to this two lens stack results in unexpected useful properties. Starting from Equation (1) and first considering two cylindrical lenses at 90 degrees to each other (δ=90 degrees) that have an optical power of D₀ and D₉₀ it can be seen that they will have a combined cylindrical power of D₀-D₉₀. Then, it was found that when two orthogonal cylindrical lenses are combined with a third cylindrical lens, D₄₅ at an angle, δ, of 45 degrees relative to the axis of D₀, the combined spherical power of three cylindrical lens combination becomes

$$Ds = \frac{{D}_{0} + {D}_{45} + {D}_{90} - Dc}{2} , \qquad ( 3 )$$

and the combined cylindrical power becomes

Dc=(D₀−D₉₀)²+D²₄₅ (4).

The angle of the cylindrical symmetry axis of the resulting three lens combination relative to D₀ axis is found to be.

$$α = {tan}^{- 1} ( \frac{{D}_{45}}{{D}_{0} - {D}_{90}} ) . \qquad ( 5 )$$

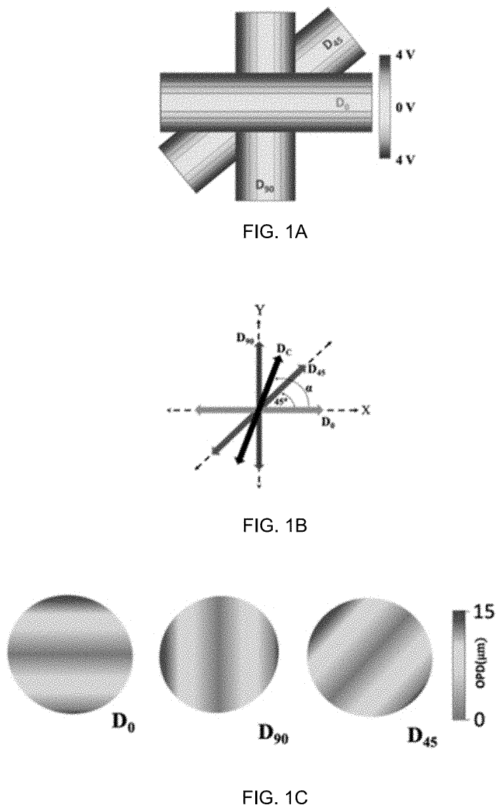

FIGS. 1A and B are schematic diagrams of the LC based tunable three cylindrical lens device. FIG. 1A shows a stack of three lenses centering at one common point, and their respective orientation along X-axis, rotated by +45 degrees and along Y-axis. Gradient change of color on the lens surface represents schematically the magnitude of the effective optical phase. FIG. 1C shows the phase gradients on the planes of the lenses.

Inversely, solving Equations 3-5 can provide the value of the three cylindrical lenses D₀, D₄₅, and D₉₀ for a corresponding prescription value (cylindrical power, DS; spherical power, D_{c}; and angle of principal axis, α).

Using Equations (3) and (4) to solve for D₁₃, defined as: D₁₃=D₀−D₉₀

$${D}_{13}^{2} = \frac{{D}_{c}^{2}}{( 1 + {tan}^{2} ( 2 α ) )} . \qquad ( 6 )$$

Sign of D₁₃ is ‘+’ if |α|>45; is ‘−’ if |α|<45. From equation ‘5’, can solve for D₄₅:

D₄₅=D₁₃ tan(2α) (7).

Sign of D₂ is ‘+’ if the sign of α is ‘−’; is ‘−’ if the sign of α is ‘+’.

From equation (3), D₉₀ can be solved for:

$${D}_{90} = {D}_{s} - \frac{{D}_{13} + {D}_{45} - {D}_{c}}{2} . \qquad ( 8 )$$

And from the definition of D₁₃, D₀ can be determined:

D₀=D₁₃+D₉₀ (9)

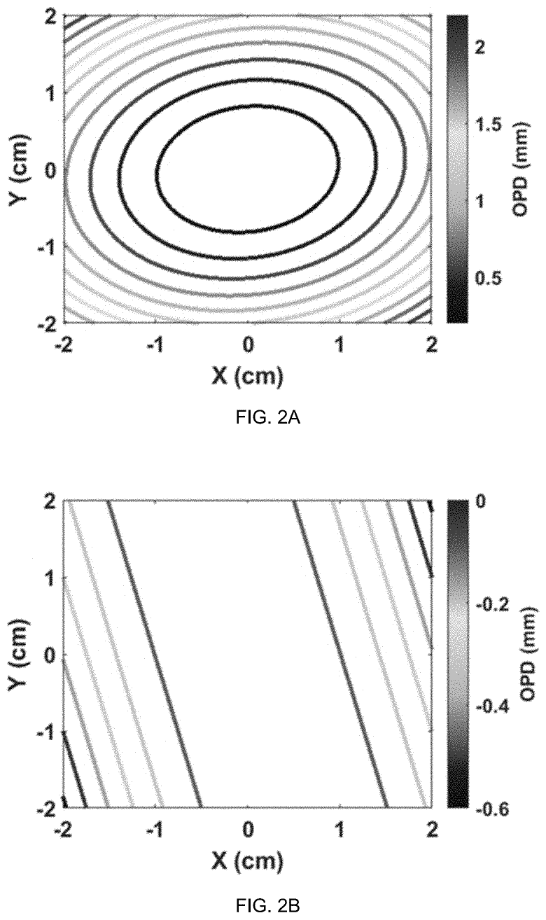

By tuning the power of three cylindrical lens D₀, D₉₀, and D₄₅, a non-mechanical wavefront corrector device capable of dynamic change of focal length and astigmatism (power and axis) can be provided. As an example, consider the design of α lens that has −6D of desired cylindrical power and +2D of desired spherical power, with the axis of cylindrical symmetry at 15 degrees from the symmetry axis of D₀. From the established formulas, power of three lenses can be determined as D₀=−4.634 D, D₄₅=1.0 D, D₉₀=−6.366 D. FIG. 2A shows a contour plot of the resulting optical phase profile expressed as the total optical path length (OPD=optical phase*λ/2π) of three lens device, where k is the wavelength of light. To see the cylindrical component of the resultant power alone, a spherical power of 6D is added to three lens device. The resulting profile (FIG. 2B) is purely cylindrical and with the angle of the symmetry axis from the symmetry axis of D₀ as calculated from the desired lens specification.

The device concept may utilize three tunable cylindrical lenses. The three tunable liquid crystal lenses may be stacked and aligned such that the center of all the lenses lies along a common axis perpendicular to the plane of the lenses, and the symmetry axis of the three lenses are along 0°, 45°, and 90°, respectively, shown in FIG. 1.

The tunable optical phase profile of each lens is controlled by the gradient in the index of refraction for each of the three cylindrical lenses, which is created by controlling the orientation of the liquid crystal director. The effective extraordinary index of refraction of a liquid crystalline material is a function of the angle of the director with respect to the direction of light propagation as given by equation 10. It can be seen that the effective value of, n_{e,effective} varies from nₒ to nₑ. As is also well known, this angle can be controlled by the application of an electric field applied across the thickness of the liquid crystal layer. To make a cylindrical lens it is required that the effective index of refraction varies according to equation 11 along one axis (where D is the power of the lens in diopters; d is the thickness of the liquid crystal layer, r is the lens radius variable, and R is the lens radius, in meters). Therefore, it is required to be able to provide an electric field across the thickness of the liquid crystal layer that varies along a defined in-plane axis.

$${n}_{e , effective} = \frac{{n}_{o} {n}_{e}}{\sqrt{{n}_{e}^{2} {cos}^{2} ( θ ) + {n}_{o}^{2} {sin}^{2} ( θ )}} \qquad ( 10 )$$

$$OPD ( r ) = ( {n}_{e , eff} ( r ) - {n}_{o} ) d \approx \frac{\vert D \vert}{2} ( {R}^{2} - {r}^{2} ) , D positive \qquad ( 11 a )$$

$$OPD ( r ) = ( {n}_{e , eff} ( r ) - {n}_{o} ) d \approx \frac{\vert D \vert}{2} {r}^{2} , D negative \qquad ( 11 b )$$

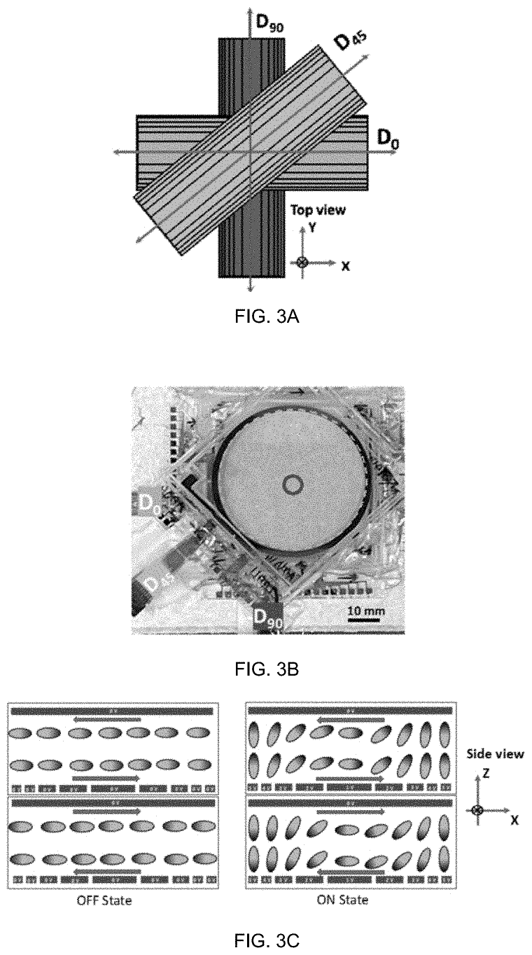

FIG. 3A is a top view schematic diagram of a LC based tunable three cylindrical lens device in accordance with some embodiments of the present disclosure. With the same viewpoint as FIG. 1A. Here, the stripes are show the direction of the linear electrodes that are on the placed on the inner surface of one of the substrates of each lens.

FIG. 3B is a top view of a fabricated device, wherein the green dotted circle represents that active area and red circle represents 5 mm diameter lens area at the center of the device.

FIG. 3C includes side views of one of the lenses (D₉₀) of FIG. 3B within the red circle area in the OFF state (left) and the ON state (right). The lens includes two liquid crystal cells (anti-parallel rubbed) where the electrodes on the inner substrates are seen edge-on. Both figures only show a small representative number of the electrodes. The blue arrows show the rub direction of the surface alignment layer, green ellipses represent LC director. Approximate voltage values are assigned on the stripe electrodes and common electrode to represent the OFF/ON state.

Shown are two glass substrates that are spaced apart by a thickness, d, of several microns that have a liquid crystal material between them. To provide the required electric field variation along one axis (the horizontal axis in FIG. 3C), linear transparent electrodes are patterned on one substrate. These electrodes are shown conceptually in side view in FIG. 3C and from the direction perpendicular to the view of FIG. 3A (for each of the three required tunable cylindrical lenses). On the other glass substrate is placed a continuous electrode that is at a fixed potential. The linear electrodes have a non-constant width with respect to their distance from the center of the lens. This is due to the desire to have the change in optical phase, and therefore the change in OPD, and therefore the change in the index of refraction between any two electrodes to be approximately constant across the aperture of the device. Because a parabolic phase profile is required for the desired cylindrical lens, the width of the electrodes varies along the desired phase gradient axis. The substrates also are coated with a polymer layer used to orient the liquid crystal director to lie along a defined axis when no voltage is applied (the horizontal axis in FIG. 3C), and to maintain the director in the x-z plane when a voltage is applied to the linear electrodes (the plane of FIG. 3C).

By controlling the voltage applied to the linear electrodes of each tunable cylindrical lens with the defined basic structure, it is possible to provide the three tunable cylindrical lenses needed to realize the device concept.

For a more detailed description of the device structure, additional factors should be considered including: the desired optical power and aperture size of the lens; the desired dynamic response time of the device; and the detailed electrode structure and methods for the application of a voltage to each electrode.

The detailed design of the lens starts with the desired power and aperture.

These quantities determine the change is the optical path difference between the center and outer edge of the lens as given by Eqn. 11. It can be seen that the highest power of the lens (the shortest focal length) will result in the maximum change in the OPD going from the center to the edge of the lens.

Because it is possible to change the phase profile of the lens from being convex to concave by changing the voltages applied to the electrodes, the maximum power change of a lens is twice that given by this equation. The maximum value of the optical path difference that can be obtained for a given liquid crystal device is given by the thickness of the layer a material where the index of refraction varies from a minimum to maximum value across the desired lens radius. In the case of a liquid crystal layer of thickness ‘d’ with birefringence ‘Δn’: OPDₘₐₓ=Δn d.

Another factor related to the lens design is the required optical response time. Liquid crystal devices of the type considered here have a maximum response time that is proportional to the square of the distance ‘d’ between the glass substrates that contain the liquid crystal material. This requirement is in conflict with the thickness value given by the OPD equation. It can be seen that, for a given liquid crystal material value of birefringence, that the response time is approximately proportional to the 4^{th} power of the lens radius. Given that the value of the birefringence of available materials is limited to approximately 0.3, if the maximum response time is chosen to be in the range of seconds, it turns out the maximum thickness is in the range of a few 10s of microns. It can be readily seen from the equations above for a +−1D lens, (2D change) the maximum radius of the lens appears to be limited to about 3 or 4 mm. This limit however can be expanded by utilizing a segmented phase profile. The maximum lens radius allowed for a given specified power and response time can be increased by dividing the phase profile of the lens into N parabolic phase segments, where in each segment the phase varies from the over the range given by the equation above. In this case the effective change in OPD going from the center to edge of the lens is given by N*OPDₘₐₓ.

Another factor related to the lens design considered here is the detailed electrode structure and how the voltages are applied. The basic electrode structure is determined by N*OPDₘₐₓ, and the maximum OPD change between two electrodes (AU) allowable. A stepped OPD profile will have an efficiency of >95% if the phase step between electrodes, ΔΓ, is <⅛ wave. For the chosen value of ΔΓ, the number of electrodes along a lens radius will be N*OPDₘₐₓ/ΔΓ.

For a 1 cm diameter lens capable of a power change of 2 Diopters, it can be seen from the previous considerations that the number of electrodes required will be in the hundreds. To be able to provide voltages to 100's of electrodes may be accomplished utilizing inter-ring resistors between all electrodes in each parabolic phase segment, and between 2 and 10 bus line connections between chosen electrode in a parabolic phase segment to an external connector. Therefore, with less than 10 externally provided adjustable voltage levels, a lens with even 1000 electrodes can be addressed.

Another consideration related to the electrode design is also described for a spherical lens. It is shown that by adding a second layer of “floating electrodes” light scattering related to the gaps between the driven electrodes described in the previous paragraphs can be reduced or eliminated.

A final factor, which can be utilized in the design of the lens system is related to the effect of off-axis light propagation through the device. It is well known that the phase retardation of a liquid crystal device is dependent on the angle of light passing through it. This problem is substantially removed by using a pairing of each lens with a counterpart that is aligned with the tilt sense of the director away from the surface to be opposite from each original lens.

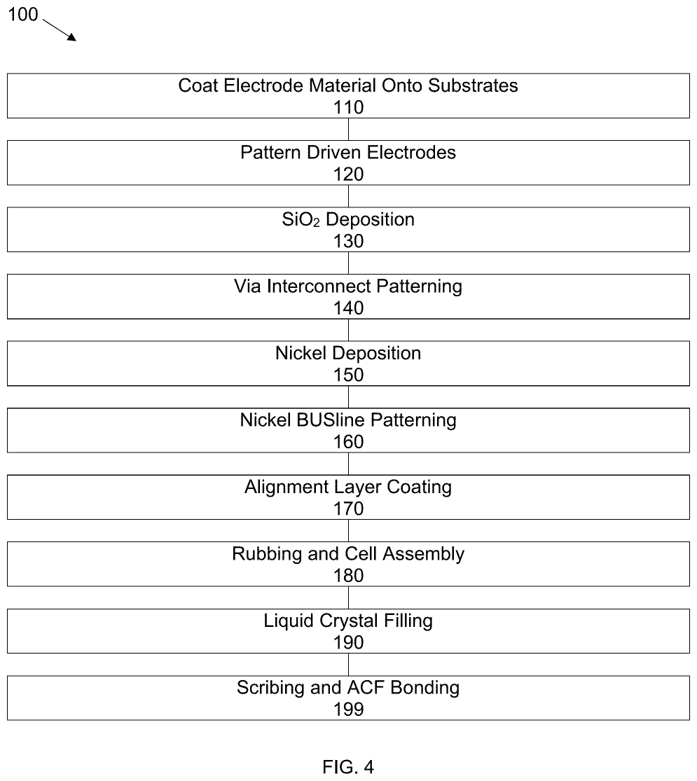

FIG. 4 is a flow chart illustrating a non-limiting lens fabrication method 100 in accordance with some embodiments of the present disclosure. The method 100 includes coating an electrode material on the substrate 110, patterning the driven electrodes 120, depositing (e.g., vacuum sputtering) SiO₂ or another insulating composition 130, via interconnect patterning 140 (e.g., etching away the insulating composition from a patterned via location, deposition (e.g., vacuum sputtering) of nickel or a similar material 150, BUSline patterning 160 to create bus line connections to externally supplied voltages, alignment layer (e.g., polyimide) coating 170, rubbing an cell assembly 180, liquid crystal filling 190, and scribing and bonding (e.g., ACF bonding) 199.

High precision silica or other spacers may be applied on the bottom plate. Thermal epoxy glue may be dispensed to create perimeter seal

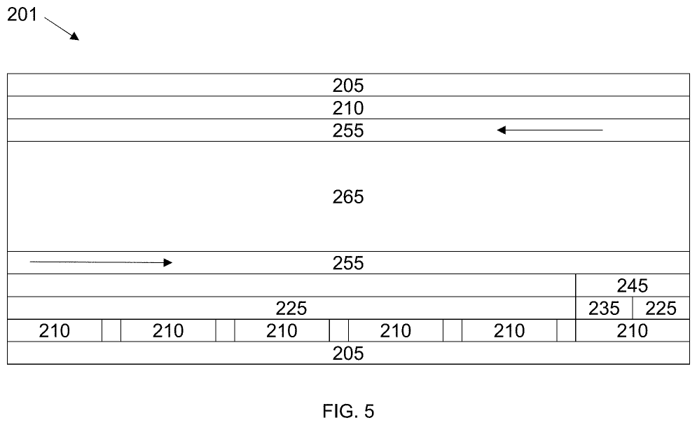

FIG. 5 illustrates a liquid crystal lens 201 in accordance with some embodiments of the present disclosure. The lens 201 includes transparent (e.g., glass) substrates 205, ITO electrodes 210, a layer containing SiO₂ 225 and ITO-nickel via interconnect 235, nickel 245, alignment layers 255 with arrows indicating rubbing directions, and a liquid crystal layer 265. Although specific materials are disclosed, it should be understood that these are merely non-limiting examples.

The structure of the device considered above may be polarization dependent, as only the extra-ordinary index of the liquid crystal material is affected by the director orientation. However, duplicating each cell with another that is aligned with a crossed in-plane alignment orientation removes this restriction.

Polarization independence of devices of the present disclosure may be obtained by comprising each of the three cylindrical lenses with 2 liquid crystal cells that have their alignment direction placed antiparallel with each other.

The aperture size may be more than 1 mm, more than 2 mm, or more than 3 mm.

The diameter of the lens may be related to the desired focal length of the lens. For example, the ratio of the focal length to the lens diameter may be greater than 1.

The liquid crystal may have a birefringence in the range of about 0.1 to about 0.4.

Each lens includes a plurality of liquid crystal devices, also referred to herein as “cells.” Each cell includes a liquid crystal layer and transparent electrodes between transparent substrates.

Each lens may be identical with the exception of the rotation angle, δ.

Non-limiting examples of articles that may utilize the optical systems of the present disclosure include smart eyeglasses, head-mounted displays (e.g., virtual reality and augmented reality head-mounted displays), and devices subject to thermal and/or mechanical distortion. In the head-mounted devices, the systems and methods of the present disclosure may enable different uses to utilize the same device without using vision-correcting glasses. Various aspects of such devices are disclosed in U.S. Pat. Nos. 10.859,838 to Yoon et al., U.S. Pat. No. 10,861,417 to Gollier et al., U.S. Pat. No. 11,300,999 to Kadirvel et al., U.S. Pat. No. 11,586,090 to Sulai et al., and 11,587,254 to Tang et al.; and U.S. Pat. App. Pub. Nos. 2022/0146836 to Lanman, 2023/0041202 to Markovsky et al., and 2023/0066327 to Wang et al. The contents of each of these patents and publications are incorporated by reference herein in their entireties.

The devices of the present disclosure may further include a sensing system and a feedback loop.

In some embodiments, the rubbing directions of all the lenses are parallel. As a result, the outgoing beam from the device is also linearly polarized and the polarization direction is parallel to the common rubbing direction.

The systems and devices of the present disclosure may include one or more power sources or power may be provided from an external source. For example, batteries, wireless power, and/or wired connections may be utilized. Each lens, cell, or electrode may utilize the same power source of different power sources.

The following examples are provided to illustrate the devices and methods of the present disclosure. The examples are merely illustrative and are not intended to limit the disclosure to the materials, conditions, or process parameters set forth therein.

### Examples

To verify the device concept, an example device was designed and fabricated. The far-field spot profile at the focal plane of the designed device is simulated and compared with a fabricated device.

The example fabricated device has an aperture size of 5 cm. It uses a segmented phase profile with 28 phase resets to overcome the switching speed limitation of the large aperture liquid crystal lens device.

The fabricated device has a constant electrode gap between adjacent stripe electrodes throughout the lens aperture. Due to phase sag within the electrode gap width, there could be a slight haze introduced. To overcome the effect of electrode gaps, another layer of electrodes (“floating electrodes”) on top of the bottom linear electrodes is utilized.

Each cylindrical lens includes of a stack of two cells to mitigate the off-axis changes in phase retardation. The liquid crystal director in each cell has a preferred tilt angle about an axis that is in the plane of the cell and perpendicular to the plane of the directors that is induced by the surface alignment has the opposite rotational sense about that axis. As a result, the proposed three-lens device has six cells.

The fabricated cells are filled with the liquid crystal MLC-2172, which has birefringence value of 0.29. The cell thickness is 20 microns which is obtained with 20-micron silica spacers. With this material and cell thickness, it is possible to have a tunable optical power range from −0.40 D to +0.40 D for each cell. When two anti-parallel aligned cells are stacked together to make a lens, the optical power range become tunable between −0.80 D to +0.80 D. With an additional +0.75 D glass lens, a tunable focus and astigmatism correction device with optical power range from −0.05 D to +1.55 D can be demonstrated. To further increase the optical power range, a larger birefringence, larger cell thickness, more phase resets, or an increased number of cells can be used.

With the desired radius of the lens and phase steps per electrodes, the total number of electrodes and their width is determined. In this example device there are 2729 linear electrodes. To apply a desired voltage to each electrode in a cell, an inner-electrode resistor network to reduce number of electrical connections is used. Externally applied voltages are only connected to few addressable electrodes that are connected with the inner-electrode resistors.

The relationship between change of voltage and change of phase of liquid crystal materials is not linear over the entire range of desired phase. However, the phase vs voltage curve can be considered to be linear over about 8 voltage regions. Therefore, to obtain a well-controlled lens phase profile, 8 externally supplied voltages are applied to 8 electrodes in each phase segment. Between each pair of externally connected electrodes, are about eight or nine electrodes with inter-electrode resistors whose voltage then varies linearly.

In the fabricated device prototype, nickel is used as bus lines to apply input voltage to the externally connected electrodes. Nickel is chosen because of high conductivity, so that the width of the bus line can be minimized. The linear electrodes are deposited Indium Tin Oxide (ITO) on glass. The electrodes (ITO) are electrically separated from Nickel bus line by silicon dioxide (SiO₂) insulator layer. Electrical connection of the addressable stripe electrode with input Nickel bus line voltage is achieved through patterned Via interconnect, where the deposited insulator is etched away.

The eight externally supplied voltages are connected to the nickel bus lines with a flex connector bonded to the linear electrode substrate.

All the fabrication process steps of the individual cells on the proposed device stack are similar except the rubbing process. When three cylindrical lenses are stacked, the rubbing axes of the three lenses need to be along one common direction. Therefore, the rubbing direction of the top and bottom plates of individual lens need to be along 0° , 45°, and 90°, respectively. Finally, all the fabricated lens cells are stacked with proper alignment direction using index matching fluid between two adjacent cells.

Reduction to Practice

Simulated and Experimental Far-Field Spot Profile Analysis

This section includes simulated and experimental spot profile studies of the designed and fabricated device at far-field.

For simulated results, an example astigmatism correction lens device, identical to the fabricated device, is numerically modeled. The validation of the modeled device is checked by far-field spot profile at a distance calculated from the described formula. With the designed electrode structure and defined electrode gaps, a director profile is obtained, and phase map of each lens based using the LC director relaxation modeling method. The total phase map of the three-lens device is generated by adding the calculated phase profile of the three individual lenses. Then, with total phase map, the far-field spot profile is simulated using the scalar diffraction simulation method.

For experimental measurement from the fabricated device, a He—Ne laser beam of wavelength 543.5 nm is passed through a polarizer, and neutral density filter, a 10× beam expander and a 5 mm aperture stop. The polarization axis is along the rubbing direction of lenses on the device stack.

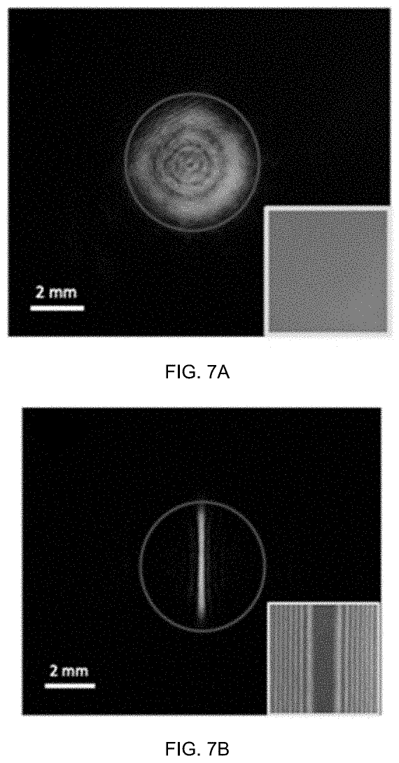

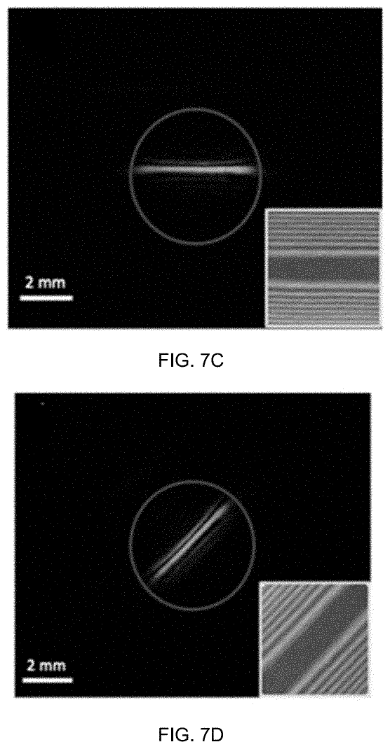

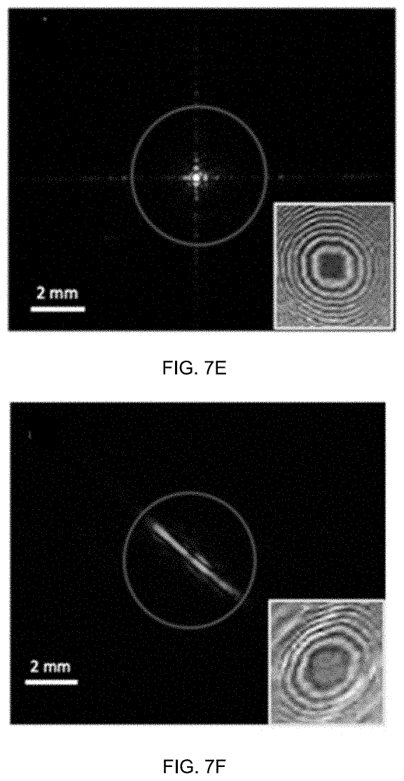

The aperture stop is centered on the center of the lens. The image created by the device at focal length of the applied power is measured using Canon Rebel XSI 450D, which has CMOS sensor with pixel size of 5.2 um. The point spread function of the device at its focal length is measured by taking intensity distribution at best focus distance. Acquired pictures are shown in FIGS. 7A-F.

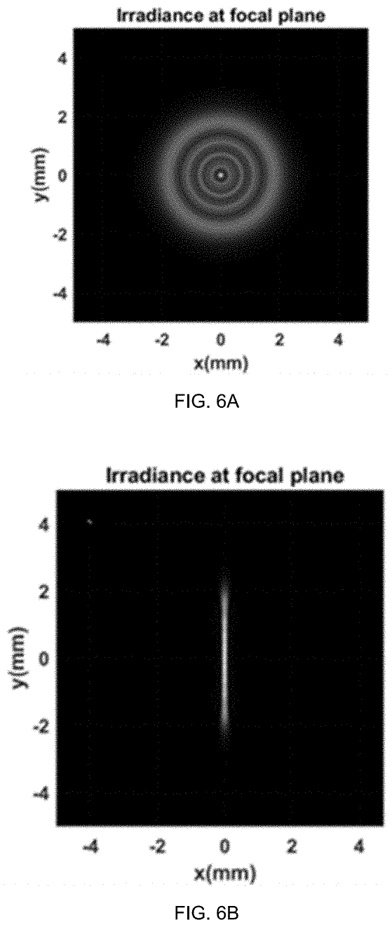

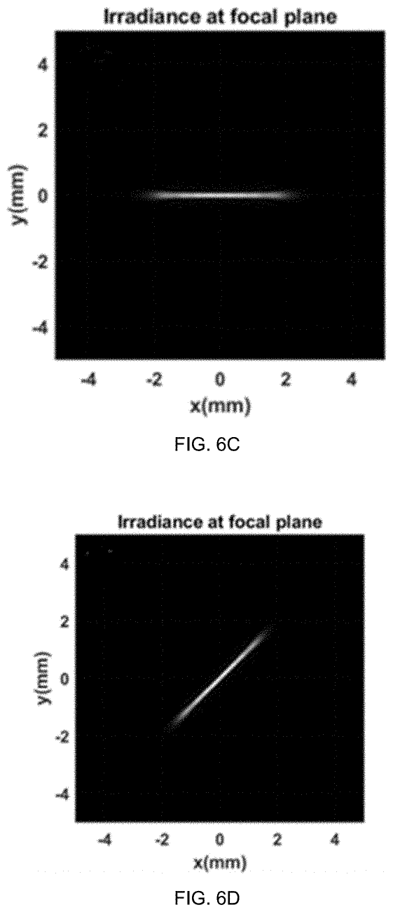

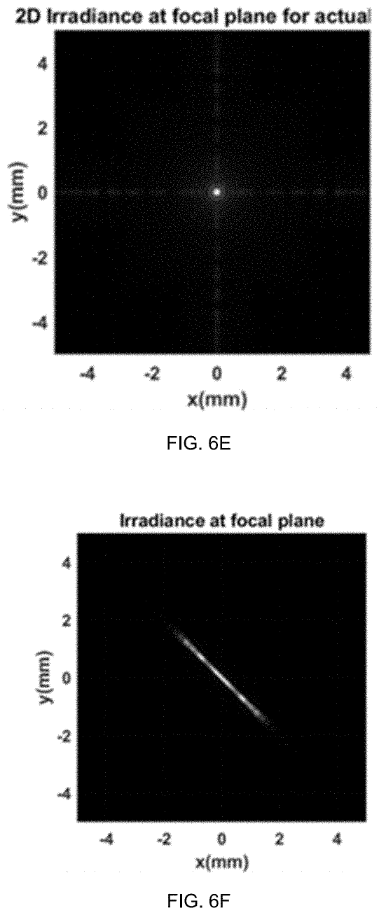

In FIGS. 6A-F and 7A-F, the power of each lens rubbed along 0°, 90°, and 45°. If one of the three lenses is powered to +0.8D, and far-field spot pictures are captured at 125 cm away from the lens stack, the far-field spot profile is recorded. It is seen the farfield image is converging into a line instead of single point for these cases. FIGS. 6A-F illustrate numerically calculated far-field spot profiles of a designed device at 125 cm distance, wherein a principal axis of the cylindrical lenses of the device are perpendicular to phase variation axis. In FIG. 6A, all LC lenses are OFF and a monochromatic light source of wavelength 543.5 nm and beam width 5 mm is passed through the simulated device. In FIG. 6B, the LC lens which has phase variation along 0°-axis has power of +0.80 D, and the other two lenses are in the OFF state. In FIG. 6C, the LC lens which has phase variation along 90°-axis has power of +0.80 D and the other two lenses are in the OFF power state. In FIG. 6D, the LC lens which has phase variation along 135°-axis has power of +0.80 D and the other two lenses are in the OFF state. In FIG. 6E, the LC lenses which have phase variation along 0°-axis and 90°-axis have power of +0.80 D, and phase variation along 135°-axis lens is at 0 D power. In FIG. 6F, all three LC lenses (D0, D90, D45) on the device stack are +0.80 D.

FIGS. 7A-F illustrate experimental far-field spot profiles of the designed device at 125 cm distant, wherein the red circle shows the original beam size. At the lower right side within the yellow box of each figure, the phase profile of fabricated LC lens for corresponding power configuration is shown. The principal axis of the cylindrical lenses of the stack is perpendicular to phase variation axis. In FIG. 7A, all LC lenses are OFF. In FIG. 7B, the LC lens which has phase variation along 0°-axis has power of +0.80 D, and other two lenses are in the OFF state. In FIG. 7C, the LC lens which has phase variation along 90°-axis has power of +0.80 D, and other two lenses are in the OFF power state. In FIG. 7D, the LC lens which has phase variation along 135°-axis has power of +0.80 D, and other two lenses are in the OFF state. In FIG. 7E, the LC lenses which have phase variation along 0°-axis and 90°-axis have optical power of +0.80 D, and the 135°-axis phase variation lens is at 0 D power. In FIG. 7F, all three LC lenses (D0, D90, D45) on the device stack are at +0.80 D.

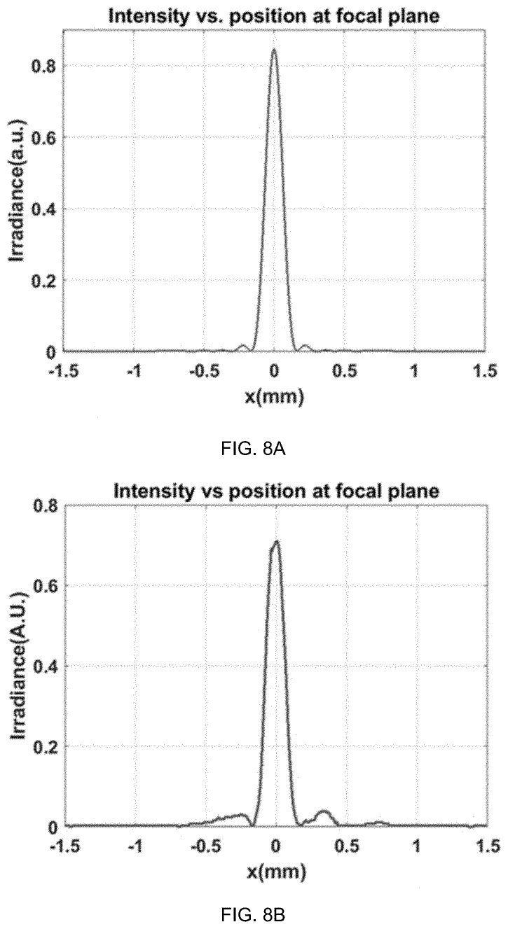

To compare the device performance at the center within 5 mm aperture diameter, intensity profile was measured at far-field distance which corresponds to distance measured from described device formula. For comparison, cases shown in FIGS. 6D and 7D are considered. The measured intensity profile is normalized by an ideal diffraction limited lens intensity profile of the same optical power. From the diffraction limited lens, the diameter of the first lobe of the Airy pattern is 320 microns. Compared to the diffraction limited first lobe diameter, the measured diameter from the simulated device is 320 microns and 330 microns from the fabricated device. Although width of first lobe for case described in FIG. 8D is close to diffraction limited performance, there is drop of normalized peak irradiance due to haze/scattering of light from multiple sources (electrode gap, air gap between device cell stack, spacer size, spacer density, etc.). Normalization of irradiance at the focal plane is measured based on maximum irradiance of diffraction-limited ideal lens. Haze due to electrode gap can be improved with floating electrodes, which will increase diffraction efficiency. FIG. 8A-B includes graphs comparing experimentally obtained far-field intensity profile with modeled diffraction limited device far-field intensity profile at focal plane. FIG. 8A shows the simulated intensity profile of the modeled device at power configuration shown in FIG. 6D. FIG. 8B shows the experimentally obtained intensity profile for the case described in FIG. 7D.

### Astigmatism Correction Example

To demonstrate the device capability of correcting astigmatism and focus without any mechanical movement, a case was considered where the desired values of Ds, Dc and α are 0.12D, 0.57D, 22.5°. From eqns. 7-9 the calculated values of the three lenses are: 0D, 0.4D, 0.4D along 0°, 90°, 45°, respectively.

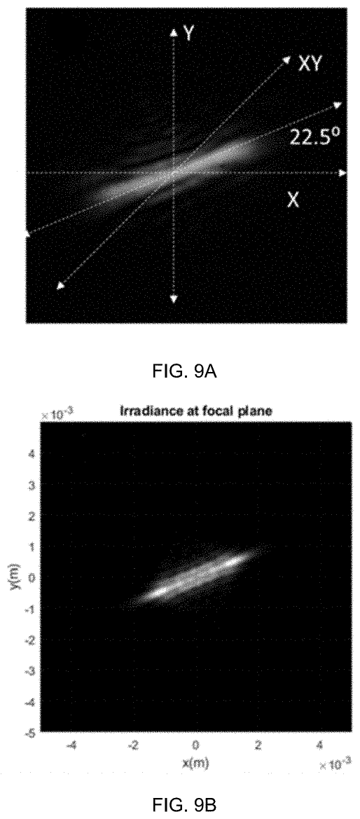

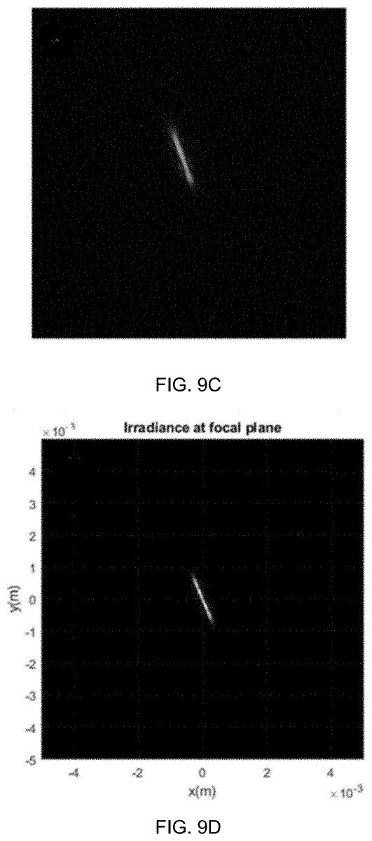

The far-field spot profile is measured at each focal plane corresponds to calculated spherical power, Ds, and cylindrical power, Dc. In FIGS. 9A-D, the measured spot profile is compared to simulated result of the same device with similar power condition. To keep the spot profile within the optical setup, a spherical glass lens of power +1.33D is used to get experimental (FIG. 9C) and simulation (FIG. 9D) results. FIG. 9A-D includes images from a tunable prescription (Rx) correction example. FIG. 9A shows the experimental far-field spot profile of the device at the focal plane of cylindrical power. FIG. 9B shows the simulated far-field spot profile of the device at the focal plane of cylindrical power. FIG. 9C shows the experimental far-field spot profile of the device at the focal plane of spherical power FIG. 9D show the simulated far-field spot profile of the device at the focal plane of spherical power.

The image formed by the device that corresponds to the spherical power (0.12 D) and cylindrical power (0.57 D) creates sharp images at two different focal planes, which are perpendicular to each other. Such behavior of the device explains the spherocylindrical or astigmatic lens properties of the device. The angle of axis (22.5°) of final power of the device is not related to gradient change of index of any lenses on the stack, hence proves the non-mechanical astigmatism correction concept. By tuning the optical power of the cylindrical LC lenses of the device the focal plane distance and angle of the axis can be dynamically changed.

Imaging Demonstration of Astigmatism Correction.

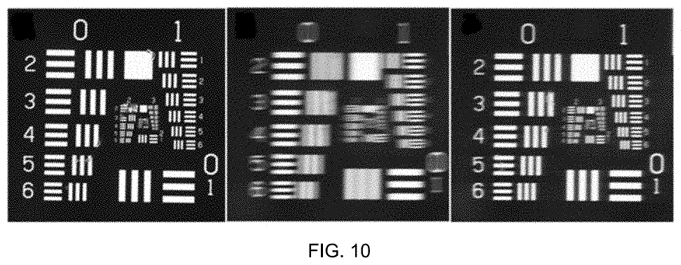

With white light illumination, it is demonstrated in FIG. 10 that the designed and fabricated lens can correct astigmatism if an image initially showing an astigmatism aberration along one direction. For this demonstration, white light is passed through an air force chart and polarizer with polarization direction parallel to rub direction of the device. Images formed at the device are captured by Canon 450D DSLR with 100 mm macro lens. Astigmatism along horizontal direction is imposed on the air force chart picture by a glass cylindrical lens of power +0.75 D (center). Astigmatism is found to be compensated when the LC lens device stack power configuration is −0.80D, 0 D, 0 D along 0°, 90°, 45°, respectively; shown at right.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A liquid crystal device comprising:
a first liquid crystal based cylindrical lens comprising a first plurality of liquid crystal cells;
a second liquid crystal based cylindrical lens aligned with the first liquid crystal based cylindrical lens with its center lying on a common center axis perpendicular to the plane of the lenses and rotated about that axis by 45° in a first direction relative to the first liquid crystal based cylindrical lens, the second liquid crystal based cylindrical lens comprising a second plurality of liquid crystal cells; and
a third liquid crystal based cylindrical lens aligned with the first liquid crystal based cylindrical lens and the second liquid crystal based cylindrical lens so that the center of the third lens lies along a common center axis perpendicular to the plane of the lenses and is rotated by 90° about that axis relative to the first liquid crystal based cylindrical lens, the third liquid crystal based cylindrical lens comprising a third plurality of liquid crystal cells.

2. The liquid crystal device of claim 1, wherein the first plurality of liquid crystal cells comprises two liquid crystal cells with anti-parallel surface alignment.

3. The liquid crystal device of claim 1, wherein the second plurality of liquid crystal cells comprises two anti-parallel surface aligned liquid crystal cells.

4. The liquid crystal device of claim 1, wherein the third plurality of liquid crystal cells comprises two anti-parallel rubbed liquid crystal cells.

5. The liquid crystal device of claim 1, wherein each cell is filled with a nematic liquid crystal with a positive dielectric anisotropy.

6. The liquid crystal layer of claim 1, wherein each cell further comprises a plurality of electrodes; wherein the electrodes and the liquid crystal layer are located between a first transparent substrate and a second transparent substrate.

7. The liquid crystal device of claim 1, wherein the electrodes comprise stripe electrodes.

8. The liquid crystal device of claim 1, wherein the electrodes comprise indium tin oxide (ITO).

9. The liquid crystal device of claim 1, wherein the device has no mechanically moving parts.

10. The liquid crystal device of claim 1, wherein a driving voltage of the device is less than 5 volts.

11. The liquid crystal device of claim 1, wherein the device is flat.

12. The liquid crystal device of claim 1 wherein the device has a thickness of about 5 mm.

13. An article comprising the liquid crystal device of claim 1.

14. The article of claim 13, wherein the article is selected from the group consisting of eyeglasses, telescopes, and imaging lenses.

15. A non-mechanical device for correcting for astigmatism over a wide range of resulting power and angle of a phase gradient axis.

16. The non-mechanical device of claim 15, wherein the range of power is between −10 and +10 Diopters.

17. The non-mechanical device of claim 15, wherein the range in the phase gradient axis angle is between 0 and 360 degrees.

18. The non-mechanical device of claim 15 wherein the correction is based on optical phase retardation versus voltage of a liquid crystal device.

19. The non-mechanical device of claim 15, wherein the device comprises three cylindrical lenses stacked in optical series such that light passes through each lens sequentially.

20. The non-mechanical device of claim 19, wherein the three cylindrical lenses are rotated relative to each other about an axis perpendicular to the plane of the lenses, the angle of the second lens being at 45 degrees relative to the first lens, and the third lens being at 90 degrees relative to the first lens.
